(19) United States
(12) Patent Application Publication
(10) Pub. No.: US 2007/0118374 A1
(43) Pub. Date: May 24, 2007

(54) METHOD FOR GENERATING CLOSED CAPTIONS

(76) Inventors: Gerald Bowden Wise, Clifton Park, NY (US); Louis John Hoebel, Burnt Hills, NY (US); John Michael Lizzi, Wilton, NY (US); Wei Chai, Niskayuna, NY (US); Helena Goldfarb, Niskayuna, NY (US); Anil Abraham, New York, NY (US); Richard Louis Zinser, Niskayuna, NY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/552,533

(22) Filed: Oct. 25, 2006

Related U.S. Application Data
(63) Continuation-in-part of application No. 11/528,936, filed on Sep. 28, 2006.
Application No. 11/528,936 is a continuation-in-part of application No. 11/287,556, filed on Nov. 23, 2005.

(51) Int. Cl. G10L 15/26

(52) U.S. Cl. 704/235; 704/233

(57) ABSTRACT

A method for detecting and modifying breath pauses in a speech input signal includes detecting breath pauses in a speech input signal; modifying the breath pauses by replacing the breath pauses with a predetermined input and/or attenuating the breath pauses; and outputting an output speech signal. A computer program for carrying out the method is also presented.

### CROSS REFERENCE TO RELATED APPLICATION

This application is a continuation in part of U.S. patent application Ser. No. 11/528,936 filed Oct. 5, 2006, and entitled “System and Method for Generating Closed Captions”, which, in turn, is a continuation in part of U.S. patent application Ser. No. 11/287,556, filed Nov. 23, 2005, and entitled “System and Method for Generating Closed Captions.”

### BACKGROUND

The invention relates generally to generating closed captions and more particularly to a system and method for automatically generating closed captions using speech recognition.

Closed captioning is the process by which an audio signal is translated into visible textual data. The visible textual data may then be made available for use by a hearing-impaired audience in place of the audio signal. A caption decoder embedded in televisions or video recorders generally separates the closed caption text from the audio signal and displays the closed caption text as part of the video signal.

Speech recognition is the process of analyzing an acoustic signal to produce a string of words. Speech recognition is generally used in hands-busy or eyes-busy situations such as when driving a car or when using small devices like personal digital assistants. Some common applications that use speech recognition include human-computer interactions, multi-modal interfaces, telephony, dictation, and multimedia indexing and retrieval. The speech recognition requirements for the above applications, in general, vary, and have differing quality requirements. For example, a dictation application may require near real-time processing and a low word error rate text transcription of the speech, whereas a multimedia indexing and retrieval application may require speaker independence and much larger vocabularies, but can accept higher word error rates.

Automatic Speech Recognition (ASR) systems are widely deployed for many applications, but commercial units are mostly employed for office dictation work. As such, they are optimized for that environment and it is now desired to employ these units for real-time closed captioning of live television broadcasts.

There are several key differences between office dictation and a live television news broadcast. First, the rate of speech is much faster—perhaps twice the speed of dictation. Second, (partly as a result of the first factor), there are very few pauses between words, and the few extant pauses are usually filled with high-amplitude breath intake noises. The combination of high word rate and high-volume breath pauses can cause two problems for ASR engines: 1) mistaking the breath intake for a phoneme, and 2) failure to detect the breath noise as a pause in the speech pattern. Current ASR engines (such as those available from Dragon Systems) have been trained to recognize the breath noise and will not decode it is a phoneme or word. However, the Dragon engine employs a separate algorithm to detect pauses in the speech, and it does not recognize the high-volume breath noise as a pause. This can cause many seconds to elapse before the ASR unit will output text. In some cases, an entire 30-second news “cut-in” can elapse (and a commercial will have started) before the output begins.

In addition to the disadvantage described above, current ASR engines do not function properly if they are presented with a zero-valued input signal. For example, it has been found that the Dragon engine will miss the first several words when transitioning from a zero-level signal to active speech.

Also, Voice (or Speech) Activity Detectors (VAD) have been used for many years in speech coding and conference calling applications. These algorithms are used to differentiate speech from stationary background noise. Since breath noise is highly non-stationary, a standard VAD algorithm will not detect it as a pause.

### BRIEF DESCRIPTION

In accordance with an embodiment of the present invention, a method for detecting and modifying breath pauses in a speech input signal comprises detecting breath pauses in a speech input signal; modifying the breath pauses by replacing the breath pauses with a predetermined input and/or attenuating the breath pauses; and outputting an output speech signal.

In another embodiment, a computer program embodied on a computer readable medium and configured for detecting and modifying breath pauses in a speech input signal, the computer program comprising the steps of: detecting breath pauses in a speech input signal; modifying the breath pauses by replacing the breath pauses with a predetermined input and/or attenuating the breath pauses; and outputting an output speech signal.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a system for generating closed captions in accordance with one embodiment of the invention;

FIG. 2 illustrates a system for identifying an appropriate context associated with text transcripts, using context-based models and topic-specific databases in accordance with one embodiment of the invention;

FIG. 3 illustrates a process for automatically generating closed captioning text in accordance with an embodiment of the present invention;

FIG. 4 illustrates another embodiment of a system for generating closed captions;

FIG. 5 illustrates a process for automatically generating closed captioning text in accordance with another embodiment of the present invention;

FIG. 6 illustrates another embodiment of a system for generating closed captions;

FIG. 7 illustrates a further embodiment of a system for generating closed captions;

FIG. 8 is a block diagram showing an embodiment of a system for detecting and modifying breath pauses;

FIG. 9 is a block diagram showing further details of a breath detection unit in accordance with the embodiment of FIG. 8;

FIG. 10 is a plot of an audio signal over time versus amplitude showing an inhale and a plosive;

FIG. 11 shows two corresponding plots of audio signals over time versus amplitude showing loss of a plosive and preservation of a plosive using an enhanced performance system for detecting and modifying breath pauses;

FIG. 12 shows two corresponding plots of audio signals over time versus amplitude, the first including a breath and the second showing the breath modified with attenuation and extension;

FIG. 13 shows two corresponding plots of audio signals over time versus amplitude, the first including zero value segment and a low amplitude segment and the second showing the zero value segment and low amplitude segment modified with low amplitude zero fill; and

FIG. 14 is a flow diagram illustrating a method for detecting and modifying breath pauses.

### DETAILED DESCRIPTION OF PREFERRED EMBODIMENTS

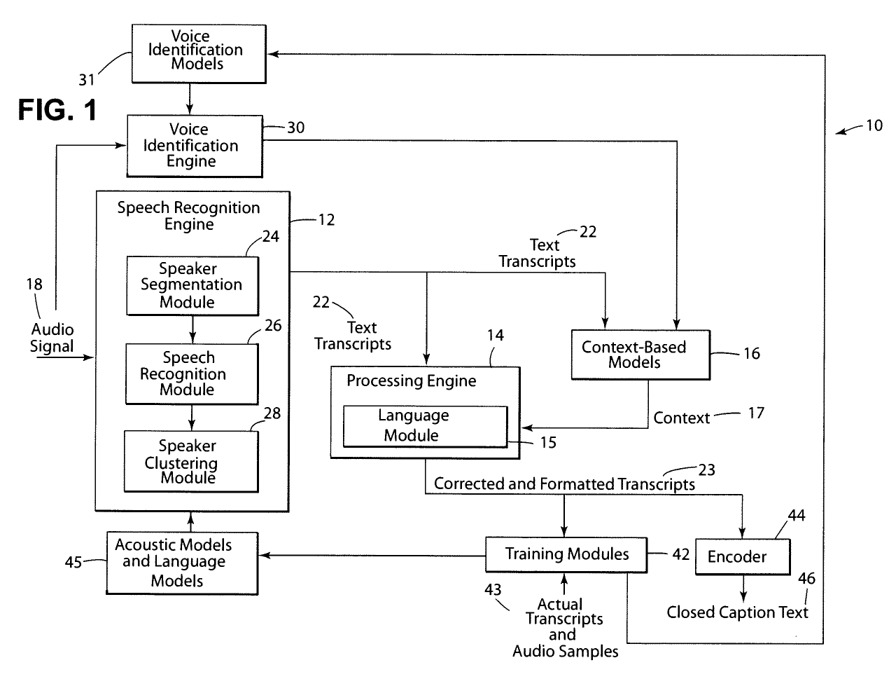

FIG. 1 is an illustration of a system 10 for generating closed captions in accordance with one embodiment of the invention. As shown in FIG. 1, the system 10 generally includes a speech recognition engine 12, a processing engine 14 and one or more context-based models 16. The speech recognition engine 12 receives an audio signal 18 and generates text transcripts 22 corresponding to one or more speech segments from the audio signal 18. The audio signal may include a signal conveying speech from a news broadcast, a live or recorded coverage of a meeting or an assembly, or from scheduled (live or recorded) network or cable entertainment. In certain embodiments, the speech recognition engine 12 may further include a speaker segmentation module 24, a speech recognition module 26 and a speaker-clustering module 28. The speaker segmentation module 24 converts the incoming audio signal 18 into speech and non-speech segments. The speech recognition module 26 analyzes the speech in the speech segments and identifies the words spoken. The speaker-clustering module 28 analyzes the acoustic features of each speech segment to identify different voices, such as, male and female voices, and labels the segments in an appropriate fashion.

The context-based models 16 are configured to identify an appropriate context 17 associated with the text transcripts 22 generated by the speech recognition engine 12. In a particular embodiment, and as will be described in greater detail below, the context-based models 16 include one or more topic-specific databases to identify an appropriate context 17 associated with the text transcripts. In a particular embodiment, a voice identification engine 30 may be coupled to the context-based models 16 to identify an appropriate context of speech and facilitate selection of text for output as captioning. As used herein, the “context” refers to the speaker as well as the topic being discussed. Knowing who is speaking may help determine the set of possible topics (e.g., if the weather anchor is speaking, topics will be most likely limited to weather forecasts, storms, etc.). In addition to identifying speakers, the voice identification engine 30 may also be augmented with non-speech models to help identify sounds from the environment or setting (explosion, music, etc.). This information can also be utilized to help identify topics. For example, if an explosion sound is identified, then the topic may be associated with war or crime.

The voice identification engine 30 may further analyze the acoustic feature of each speech segment and identify the specific speaker associated with that segment by comparing the acoustic feature to one or more voice identification models 31 corresponding to a set of possible speakers and determining the closest match based upon the comparison. The voice identification models may be trained offline and loaded by the voice identification engine 30 for real-time speaker identification. For purposes of accuracy, a smoothing/filtering step may be performed before presenting the identified speakers to avoid instability (generally caused due to unrealistic high frequency of changing speakers) in the system.

The processing engine 14 processes the text transcripts 22 generated by the speech recognition engine 12. The processing engine 14 includes a natural language module 15 to analyze the text transcripts 22 from the speech recognition engine 12 for word error correction, named-entity extraction, and output formatting on the text transcripts 22. Word error correction involves use of a statistical model (employed with the language model) built off line using correct reference transcripts, and updates thereof, from prior broadcasts. A word error correction of the text transcripts may include determining a word error rate corresponding to the text transcripts. The word error rate is defined as a measure of the difference between the transcript generated by the speech recognizer and the correct reference transcript. In some embodiments, the word error rate is determined by calculating the minimum edit distance in words between the recognized and the correct strings. Named entity extraction processes the text transcripts 22 for names, companies, and places in the text transcripts 22. The names and entities extracted may be used to associate metadata with the text transcripts 22, which can subsequently be used during indexing and retrieval. Output formatting of the text transcripts 22 may include, but is not limited to, capitalization, punctuation, word replacements, insertions and deletions, and insertions of speaker names.

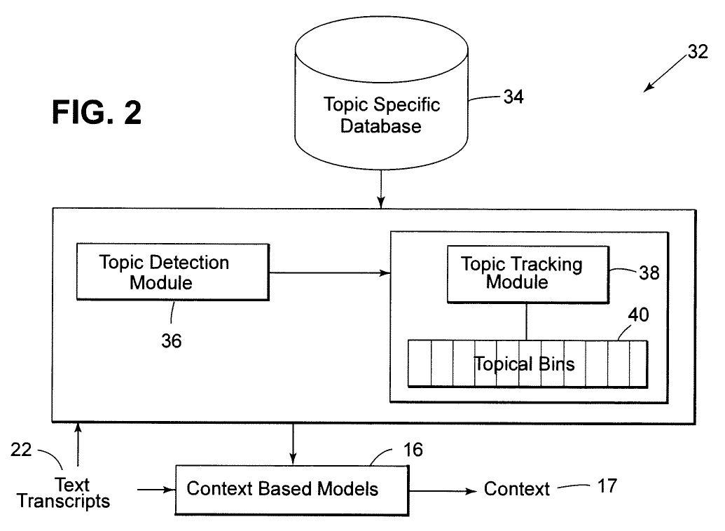

FIG. 2 illustrates a system for identifying an appropriate context associated with text transcripts, using context-based models and topic-specific databases in accordance with one embodiment of the invention. As shown in FIG. 2, the system 32 includes a topic-specific database 34. The topic-specific database 34 may include a text corpus, comprising a large collection of text documents. The system 32 further includes a topic detection module 36 and a topic tracking module 38. The topic detection module 36 identifies a topic or a set of topics included within the text transcripts 22. The topic tracking module 38 identifies particular text-transcripts 22 that have the same topic(s) and categorizes stories on the same topic into one or more topical bins 40.

Referring to FIG. 1, the context 17 associated with the text transcripts 22 identified by the context based models 16 is further used by the processing engine 16 to identify incorrectly recognized words and identify corrections in the text transcripts, which may include the use of natural language techniques. In a particular example, if the text transcripts 22 include a phrase, “she spotted a sale from far away” and the topic detection module 16 identifies the topic as a “beach” then the context based models 16 will correct the phrase to “she spotted a sail from far away”.

In some embodiments, the context-based models 16 analyze the text transcripts 22 based on a topic specific word probability count in the text transcripts. As used herein, the “topic specific word probability count” refers to the likelihood of occurrence of specific words in a particular topic wherein higher probabilities are assigned to particular words associated with a topic than with other words. For example, as will be appreciated by those skilled in the art, words like “stock price” and “DOW industrials” are generally common in a report on the stock market but not as common during a report on the Asian tsunami of December 2004, where words like “casualties,” and “earthquake” are more likely to occur. Similarly, a report on the stock market may mention “Wall Street” or “Alan Greenspan” while a report on the Asian tsunami may mention “Indonesia” or “Southeast Asia”. The use of the context-based models 16 in conjunction with the topic-specific database 34 improves the accuracy of the speech recognition engine 12. In addition, the context-based models 16 and the topic-specific databases 34 enable the selection of more likely word candidates by the speech recognition engine 12 by assigning higher probabilities to words associated with a particular topic than other words.

Referring to FIG. 1, the system 10 further includes a training module 42. In accordance with one embodiment, the training module 42 manages acoustic models and language models 45 used by the speech recognition engine 12. The training module 42 augments dictionaries and language models for speakers and builds new speech recognition and voice identification models for new speakers. The training manager 42 utilizes audio samples to build acoustic models and voice id models for new speakers. The training module 42 uses actual transcripts and audio samples 43, and other appropriate text documents, to identify new words and frequencies of words and word combinations based on an analysis of a plurality of text transcripts and documents and updates the language models 45 for speakers based on the analysis. As will be appreciated by those skilled in the art, acoustic models are built by analyzing many audio samples to identify words and sub-words (phonemes) to arrive at a probabilistic model that relates the phonemes with the words. In a particular embodiment, the acoustic model used is a Hidden Markov Model (HMM). Similarly, language models may be built from many samples of text transcripts to determine frequencies of individual words and sequences of words to build a statistical model. In a particular embodiment, the language model used is an N-grams model. As will be appreciated by those skilled in the art, the N-grams model uses a sequence of N words in a sequence to predict the next word, using a statistical model.

An encoder 44 broadcasts the text transcripts 22 corresponding to the speech segments as closed caption text 46. The encoder 44 accepts an input video signal, which may be analog or digital. The encoder 44 further receives the corrected and formatted transcripts 23 from the processing engine 14 and encodes the corrected and formatted transcripts 23 as closed captioning text 46. The encoding may be performed using a standard method such as, for example, using line 21 of a television signal. The encoded, output video signal may be subsequently sent to a television, which decodes the closed captioning text 46 via a closed caption decoder. Once decoded, the closed captioning text 46 may be overlaid and displayed on the television display.

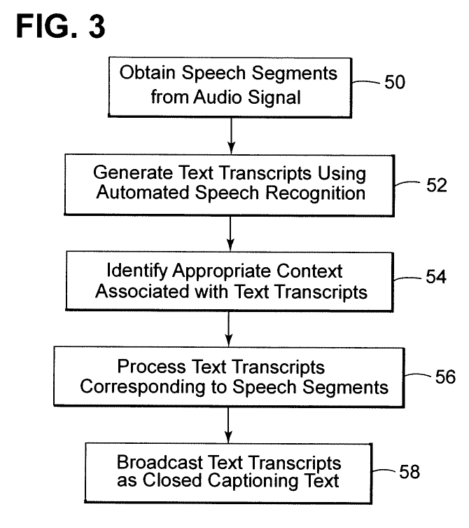

FIG. 3 illustrates a process for automatically generating closed captioning text, in accordance with one embodiment of the present invention. In step 50, one or more speech segments from an audio signal are obtained. The audio signal 18 (FIG. 1) may include a signal conveying speech from a news broadcast, a live or recorded coverage of a meeting or an assembly, or from scheduled (live or recorded) network or cable entertainment. Further, acoustic features corresponding to the speech segments may be analyzed to identify specific speakers associated with the speech segments. In one embodiment, a smoothing/filtering operation may be applied to the speech segments to identify particular speakers associated with particular speech segments. In step 52, one or more text transcripts corresponding to the one or more speech segments are generated. In step 54, an appropriate context associated with the text transcripts 22 is identified. As described above, the context 17 helps identify incorrectly recognized words in the text transcripts 22 and helps the selection of corrected words. Also, as mentioned above, the appropriate context 17 is identified based on a topic specific word probability count in the text transcripts. In step 56, the text transcripts 22 are processed. This step includes analyzing the text transcripts 22 for word errors and performing corrections. In one embodiment, the text transcripts 22 are analyzed using a natural language technique. In step 58, the text transcripts are broadcast as closed captioning text.

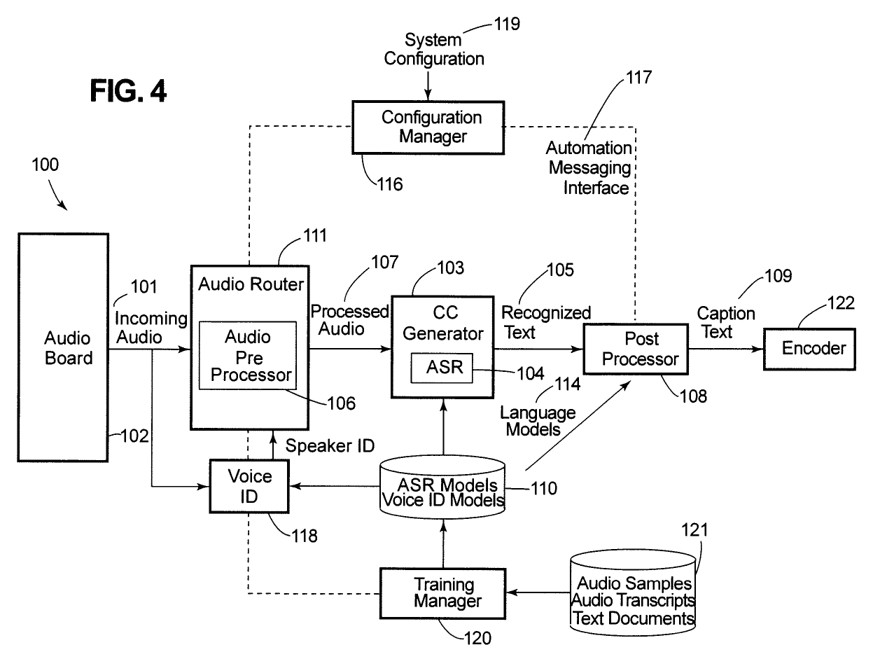

Referring now to FIG. 4, another embodiment of a closed caption system in accordance with the present invention is shown generally at 100. The closed caption system 100 receives an audio signal 101, for example, from an audio board 102, and comprises in this embodiment, a closed captioned generator 103 with ASR or speech recognition module 104 and an audio pre-processor 106. Also, provided in this embodiment is an audio router 111 that functions to route the incoming audio signal 101, through the audio pre-processor 106, and to the speech recognition module 104. The recognized text 105 is then routed to a post processor 108. As described above, the audio signal 101 may comprise a signal conveying speech from a live or recorded event such as a news broadcast, a meeting or entertainment broadcast. The audio board 102 may be any known device that has one or more audio inputs, such as from microphones, and may combine the inputs to produce a single output audio signal 101, although, multiple outputs are contemplated herein as described in more detail below.

The speech recognition module 104 may be similar to the speech recognition module 26, described above, and generates text transcripts from speech segments. In one optional embodiment, the speech recognition module 104 may utilize one or more speech recognition engines that may be speaker-dependent or speaker-independent. In this embodiment, the speech recognition module 104 utilizes a speaker-dependent speech recognition engine that communicates with a database 110 that includes various known models that the speech recognition module uses to identify particular words. Output from the speech recognition module 104 is recognized text 105.

In accordance with this embodiment, the audio pre-processor 106 functions to correct one or more undesirable attributes from the audio signal 101 and to provide speech segments that are, in turn, fed to the speech recognition module 104. For example, the pre-processor 106 may provide breath reduction and extension, zero level elimination, voice activity detection and crosstalk elimination. In one aspect, the audio pre-processor is configured to specifically identify breaths in the audio signal 101 and attenuate them so that the speech recognition engine can more easily detect speech as described in more detail below. Also, where the duration of the breath is less than a time interval set by the speech recognition module for identifying separation between phrases, the duration of the breath is extended to match that interval.

To provide zero level elimination, occurrences of zero-level energy with the audio signal 101 are replaced with a predetermined low level of background noise. This is to facilitate the identification of speech and non-speech boundaries by the speech recognition engine.

Voice activity detection (VAD) comprises detecting the speech segments within the audio input signal that are most likely to contain speech. As a consequence of this, segments that do not contain speech (e.g., stationary background noise) are also identified. These non-speech segments may be treated like breath noise (attenuated or extended, as necessary). Note the VAD algorithms and breath-specific algorithms generally do not identify the same type of non-speech signal. One embodiment uses a VAD and a breath detection algorithm in parallel to identify non-speech segments of the input signal.

The closed captioning system may be configured to receive audio input from multiple audio sources (e.g., microphones or devices). The audio from each audio source is connected to an instance of the speech recognition engine. For example, on a studio set where several speakers are conversing, any given microphone will not only pick up the its own speaker, but will also pick up other speakers. Cross talk elimination is employed to remove all other speakers from each individual microphone line, thereby capturing speech from a sole individual. This is accomplished by employing multiple adaptive filters. More details of a suitable system and method of cross talk elimination for use in the practice of the present embodiment are available in U.S. Pat. No. 4,649,505, to Zinser Jr. et al, the contents of which are hereby incorporated herein by reference to the extent necessary to make and practice the present invention.

Optionally, the audio pre-processor 106 may include a speaker segmentation module 24 (FIG. 1) and a speaker-clustering module 28 (FIG. 1) each of which are described above. Processed audio 107 is output from the audio pre-processor 106.

The post processor 108 functions to provide one or more modifications to the text transcripts generated by the speech recognition module 104. These modifications may comprise use of language models 114, similar to that employed with the language models 45 described above, which are provided for use by the post processor 108 in correcting the text transcripts as described above for context, word error correction, and/or vulgarity cleansing. In addition, the underlying language models, which are based on topics such as weather, traffic and general news, also may be used by the post processor 108 to help identify modifications to the text. The post processor may also provide for smoothing and interleaving of captions by sending text to the encoder in a timely manner while ensuring that the segments of text corresponding to each speaker are displayed in an order that closely matches or preserves the order actually spoken by the speakers. Captioned text 109 is output by the post processor 108.

A configuration manager 116 is provided which receives input system configuration 119 and communicates with the audio pre-processor 106, the post processor 108, a voice identification module 118 and training manager 120. The configuration manager 116 may function to perform dynamic system configuration to initialize the system components or modules prior to use. In this embodiment, the configuration manager 116 is also provided to assist the audio pre-processor, via the audio router 111, by initializing the mapping of audio lines to speech recognition engine instances and to provide the voice identification module 118 with the a set of statistical models or voice identification models database 110 via training manager 120. Also, the configuration manager controls the start-up and shutdown of each component module it communicates with and may interface via an automation messaging interface (AMI) 117.

It will be appreciated that the voice identification module 118 may be similar to the voice identification engine 30 described above, and may access database or other shared storage database 110 for voice identification models.

The training manager 120 is provided in an optional embodiment and functions similar to the training modules 42 described above via input from storage 121.

An encoder 122 is provided which functions similar to the encoder 44 described above.

In operation of the present embodiment, the audio signal 101 received from the audio board 102 is communicated to the audio pre-processor 106 where one or more predetermined undesirable attributes are removed from the audio signal 101 and one or more speech segments is output to the speech recognition module 104. Thereafter, one or more text transcripts are generated by the speech recognition module 104 from the one or more speech segments. Next, the post processor 108 provides at least one pre-selected modification to the text transcripts and finally, the text transcripts, corresponding to the speech segments, are broadcast as closed captions by the encoder 122. Prior to this process the configuration manager configures, initializes, and starts up each module of the system.

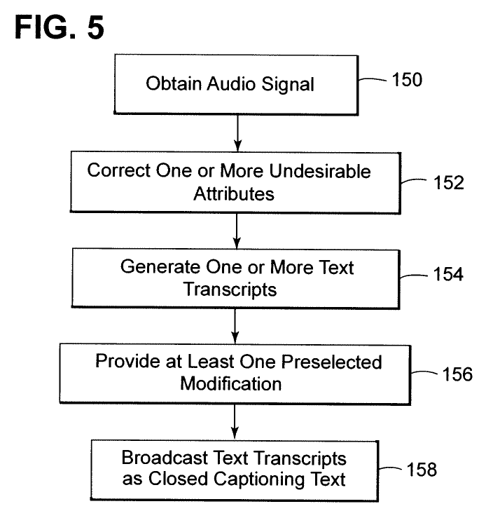

FIG. 5 illustrates another embodiment of a process for automatically generating closed captioning text. As shown, in step 150, an audio signal is obtained. In step 152, one or more predetermined undesirable attributes are removed from the audio signal and one or more speech segments are generated. The one or more predetermined undesirable attributes may comprise at least one of breath identification, zero level elimination, voice activity detection and crosstalk elimination. In step 154, one or more text transcripts corresponding to the one or more speech segments are generated. In step 156, at least one pre-selected modification is made to the one or more text transcripts. The at least one pre-selected modification to the text transcripts may comprise at least one of context, error correction, vulgarity cleansing, and smoothing and interleaving of captions. In step 158, the text transcripts are broadcast as closed captioning text. The method may further comprise identifying specific speakers associated with the speech segments and providing an appropriate individual speaker model (not shown in FIG. 5).

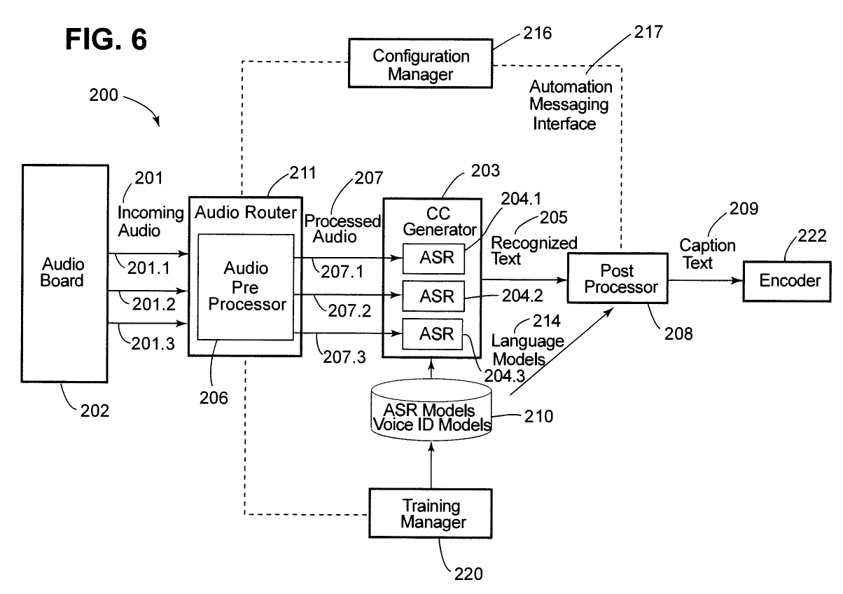

As illustrated in FIG. 6, another embodiment of a closed caption system in accordance with the present invention is shown generally at 200. The closed caption system 200 is generally similar to that of system 100 (FIG. 4) and thus like components are labeled similarly, although, preceded by a two rather than a one. In this embodiment, multiple outputs 201.1, 201.2, 201.3 of incoming audio 201 are shown which are communicated to the audio router 211. Thereafter processed audio 207 is communicated via lines 207.1, 207.2, 207.3 to speech recognition modules 204.1, 204.2, 204.3. This is advantageous where multiple tracks of audio are desired to be separately processed, such as with multiple speakers.

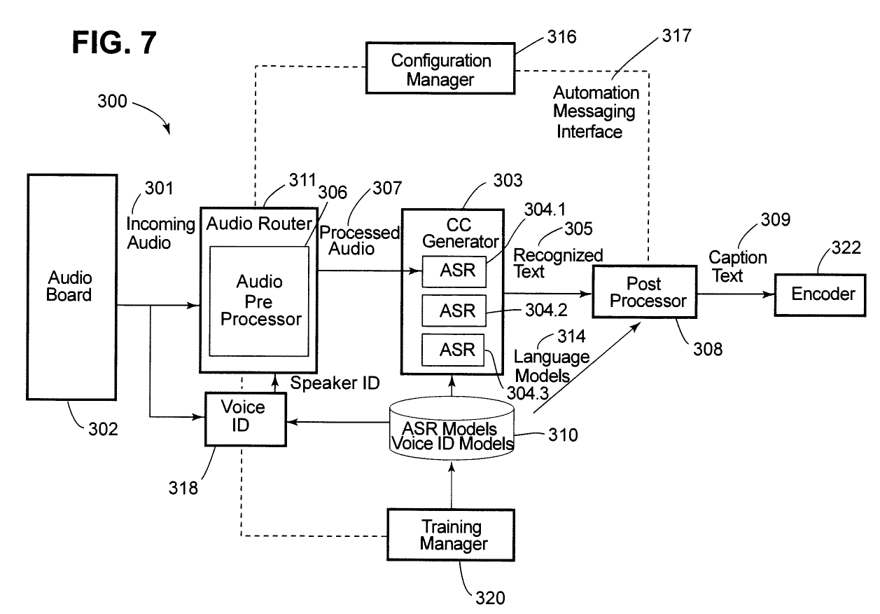

As illustrated in FIG. 7, another embodiment of a closed caption system in accordance with the present invention is shown generally at 300. The closed caption system 300 is generally similar to that of system 200 (FIG. 6) and thus like components are labeled similarly, although, preceded by a three rather than a two. In this embodiment, multiple speech recognition modules 304.1, 304.2 and 304.3 are provided to enable incoming audio to be routed to the appropriate speech recognition engine (speaker independent or speaker dependent).

In accordance with a further aspect of the present invention, a method and a device for detecting and modifying breath pauses that is employable with the closed caption systems provided above is described hereafter. The below described method and device, in one embodiment, is configured for use in an audio pre-processor of a closed caption system such as audio pre-processor 106 (see FIG. 4), described above.

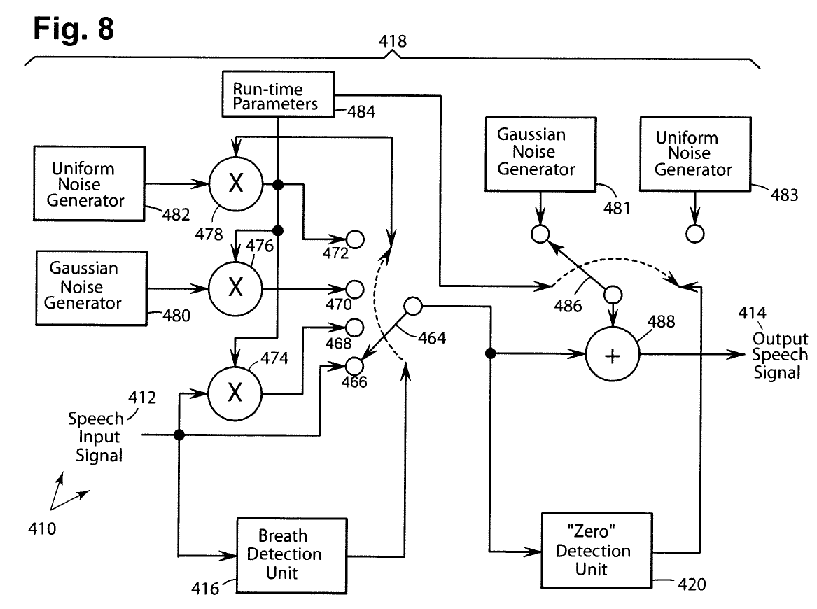

Referring now to FIG. 8, one embodiment of a system for detecting and modifying breath pauses is shown generally at 410. The system for detecting and modifying breath pauses 410 receives speech input signal at 412, e.g. in one exemplary embodiment at a frequency of 44.1/48 KHz and 16 bits of data, and outputs an output speech signal at 414. The system 410 comprises each of a breath noise detection unit 416, a modification unit 418, and a low/zero-level detection unit 420. In an optional embodiment each of the units 416, 418 and 420 may comprise one unit or one module of programming code, one component circuit including one or more processors and/or some combination thereof. It will be understood that in this embodiment, processing is carried out on a frame-by-frame basis. A frame is a block of signal samples of fixed length. In an exemplary embodiment, the frame is 20 milliseconds long and comprises 960 signal samples (at a 48 kHz sampling rate).

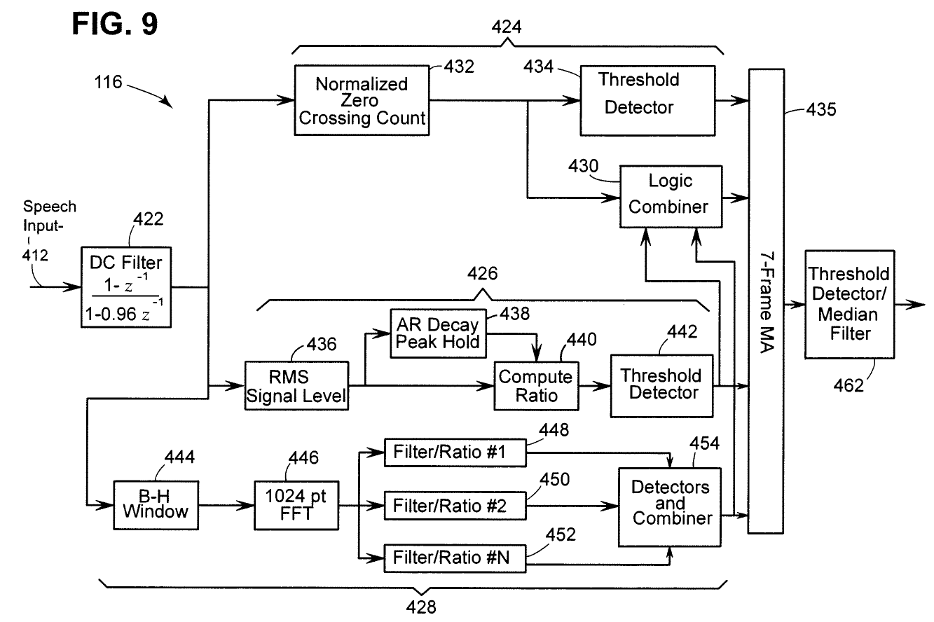

FIG. 9 shows a block diagram of one embodiment of a breath noise detection unit 416. In this embodiment, the speech input 412 is first passed through a DC blocking/high pass filter 422 which comprises a transfer function (see EQ. 1).

$$H ( z ) = \frac{1 - {z}^{- 1}}{1 - 0.96 {z}^{- 1}} \qquad ( EQ 1 )$$

In the exemplary embodiment, the choice of the pole magnitude of 0.96, in the equation above, has been found to be advantageous for operation of a normalized zero crossing count detector, described below.

In accordance with a feature of this embodiment, filtered speech input from filter 422 is conducted through at least one branch of a branched structure for detection of breath noise. As shown, a first branch 424 performs normalized zero crossing counting, a second branch 426 determines relative root-mean-square (RMS) signal level, and a third branch 428 determines spectral power ratio where, in this embodiment, four ratios are computed as described below. Each branch operates independently and contributes a positive, zero, or negative value to an array, described below, to provide a summed composite detection score (sometime referred to herein as “pscore”). Prior to further describing the pscore, it is desirable to first describe calculations carried out in each branch 424, 426 and 428.

Branch Calculations

In the first branch 424, a normalized zero crossing counter 432 (sometimes referred to herein as “NZCC”) is provided along with a threshold detector 434. The NZCC 432 computes a zero crossing count (ZCN) by dividing a number of times a signal changes polarity within a frame by a length of the frame in samples. In the exemplary embodiment, that would be (# of polarity changes)/960. The normalized zero crossing count is a key discriminator for discerning breath noise from voiced speech and some unvoiced phonemes. Low values of ZCN (<0.09 at 48 kHz sampling rate) indicate voiced speech, while very high values (>0.22 at 48 kHz sampling rate) indicate unvoiced speech. Values lying between these two thresholds generally indicate the presence of breath noise.

Output from the NZCC 432 is conducted to both the threshold dector 434 for comparison against the above-mentioned thresholds and to a logic combiner 430. Output from the threshold detector 434 is conducted to an array 435, that in the exemplary embodiment includes seven elements.

The second branch 426 functions to help detect breath noise by comparing the relative rms to one or more thresholds. It comprises an RMS signal level calculator 436, an AR Decay Peak Hold calculator 438, a ratio computer 440 and a threshold detector 442. The RMS signal level calculator 436 calculates an RMS signal level for a frame via the formula provided below in equation 2.

$$rms = \sqrt{\frac{{\sum }_{i = 0}^{N - 1} {x}^{2} ( i )}{N}} , \qquad ( EQ . 2 )$$

where x(i) are the sample values in the frame and N is the number of samples in the frame.

The ratio computer 440 computes a relative RMS level (RRMS) per frame via dividing the current frame's RMS level, as determined by calculator 436, by a peak-hold autoregressive average of the maximum RMS found by calculator 438. The peak-hold AR average RMS (PRMS) and RRMS can be calculated using the following code segment:
if (rms>prms) prms=rms;
prms*=DECAY_COEFF;
rrms=rms/prms;
   where rms is the current frame's RMS value, PRMS is the peak-hold AR average RMS, DECAY_COEFF is a positive number less than 1.0, and RRMS is the relative RMS.

In the exemplary embodiment, the value of PRMS is limited such that
300<prms<20000,
   and the decay coefficient is adjusted depending on the periodicity of the input signal and changes in the current value of RMS. For example, if the last 7 frames have been periodic, and the last frame's RMS is less than 0.15 times the value of PRMS, then a “fast” decay coefficient of 0.99 may be used. Otherwise, a “slow” decay coefficient of 0.9998 is used.

The output of the ratio computer 440 is conducted to the threshold detector 442, which compares the RRMS value to one or more pre-set thresholds. Low values of RRMS are indicative of breath noise, while high values correspond to voiced speech. Output from the threshold detector 442 is conducted to the logic combiner 430 and the array 435.

Referring now to the third branch 428, spectral ratios are computed, in one embodiment, using a 4-term Blackman-Harris window 444, a 1024-point FFT 446, N filter ratio calculators 448, 450, 452 and a detector and combiner 454 in order to compute the N spectral ratios for breath detection. The Blackman-Harris window 444 provides greater spectral dynamic range for the subsequent Fourier transformation. The filter/ratio calculators 448, 450 and 452 perform the following functions: 1) filtering by separating the Fourier transform coefficients into several bands (see Table 1), 2) summing the magnitude of the Fourier coefficients to compute signal levels for each band, and 3) normalizing signal levels in each band by a bandwidth of each particular band that may be measured in tenths of a decibel (e.g. a level of 100=10 dB). Ratios of band power levels are computed by subtracting their logarithmic signal levels (see Table 2). The outputs of the filter/ratio calculators 228, 450 and 452 are conducted to the detector and combiner 454 which functions to compare the band power (spectral) ratios to several fixed thresholds. The thresholds for the ratios employed are given in Table 2. The output of the detector and combiner 454 is conducted to the logic combiner 430 and the array 435.

In one exemplary embodiment, signal levels are computed in five (N=5; 428 of FIG. 9) frequency bands that are defined in TABLE 1.

TABLE 1

| | |
|---|---|
| Low band (lo) | 1000-3000 Hz |
| Mid band (mid) | 4000-5000 Hz |
| High band (hi) | 5000-7000 Hz |
| Low wideband (lowide) | 0-5000 Hz |
| High wideband (hiwide) | 10000-15000 Hz |

Composite Detection Score

The composite detection score (pscore) is computed by summing, as provided in the array 435, a contribution of either +1, 0, −1 or −2 for each of the branches 424, 426 and 428 described above. In addition, a non-linear combination of the features is also allowed to contribute to the pscore as provided by a logic combiner 430. In the exemplary embodiment, the pscore may be set to zero, and the following adjustments may be made, based on the computed values for each branch as provided below in TABLE 2.

TABLE 2

| Branch | Expression | Syntax |
|---|---|---|
| NZCC: | if (0.09 < ZCN < 0.22) | pscore++; |
| RRMS: | if (RRMS < 0.085) | pscore++; |
| | else if (RRMS > 0.1) | pscore−−; |
| Spectral | if (lo-hi < 5) AND (hiwide-lowide > −250) | pscore−−; |
| Ratios: | if (lo-hi < −50) | pscore−−; |
| | if (lo-mid > 200) AND (lo-hi < 120) | pscore−−; |
| | if (hiwide-lowide > −100) | pscore −= 2; |

| | |
|---|---|
| Non-linear | if the NZCC and RRMS criteria had positive contributions, |
| Comb: | and the spectral ratio net contribution was zero, pscore++ |

The thresholds and pscore actions in Table 2 were determined by observation and verified by experimentation. Spectral ratios and their associated thresholds are measured in tenths of a decibel; the ratios are determined by subtracting the logarithmic signal levels for the given bands (e.g. “lo-hi” is the low band log signal level minus the high band signal level, expressed in tenths of a decibel).

The score for each frame is computed by summing the pscores listed above in TABLE 2. To improve accuracy, the contributions from the last M frames are summed to generate the final pscore. In the exemplary embodiment, M=7. Using this value, breath noise is detected as present if the composite score is greater than or equal to 9.

It will be appreciated that this score is valid for the frame that is centered in a 7-frame sequence (using the “C” language array convention, that would be frame 3 of frames 0-6), so in this embodiment there is an inherent delay of 3 frames (60 msec).

Referring again to FIG. 9, a third order recursive median filter 462 may be employed to smooth the overall decision made by the above process. This adds another frame of delay, but gives a significant performance improvement by filtering out single decision “glitches”.

Plosive Detector

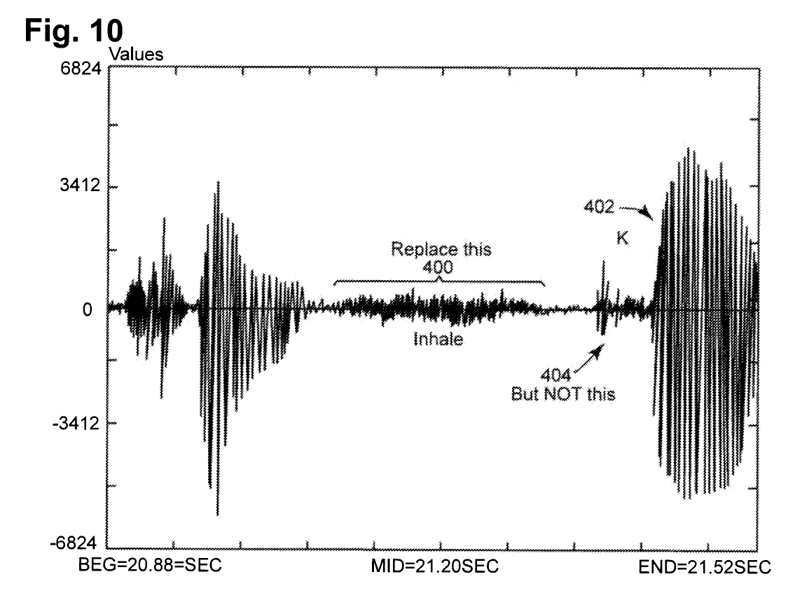

In one embodiment, the system 410 may also include a plosive detector incorporated within the breath detection unit 416 to better differentiate between an unvoiced plosive (e.g. such as what occurs during pronounciation of the letters “P”, “T”, or “K”) and breath noise. It will be appreciated that detecting breath intake noise is difficult as this noise is easily confused with unvoiced speech phonemes as shown in FIG. 10. This figure shows a time domain plot of speech with both breath noise waveform 400 and voiced phonemes waveform 402 and unvoiced phonemes waveform 404. As shown, the breath noise waveform 400 and that of a phoneme such as the letter “K” are similar, although, while it will be understood that attenuation of the “K” phoneme would adversely affect the recognizer's performance, attenuation of the breath noise would not.

It has been found that plosives are characterized by rapid increases in RMS power (and consequently by rapid decreases in the per-frame score described above). Sometimes these changes occur within a 20 msec frame, so a half-frame RMS detector is required. Two RMS values are computed, one for the first half-frame and another for the second. For example, a plosive may be detected if the following criteria are met:
1. (rms_half2/rms_half1>5) OR (rms_current-frame/rms_last_frame>5) AND
2. (NZCC has positive pscore contribution) OR (the composite detection score>3) AND
3. (the composite detection score<20).

If the foregoing conditions are met, all positive pscore contributions from the previous seven frames are set equal to zero for the current frame being processed. This zeroing process is continued for one additional frame in order to ensure that the plosive will not be attenuated prematurely creating difficulty in recognizing phonemes that follow the plosive.

In another optional embodiment, a plosive is detected by identifying rapid changes in individual frame pscore values. For example, a plosive may be detected if the following criteria are met:
1. (current_frame_pscore<0) AND (the composite detection score<20) AND
2. (the composite detection score>=9) OR (last_frame_pscore>=3).

If these conditions are met, all positive pscore contributions from the previous seven frames are set equal to zero for the current frame being processed. Again, this ensures that the plosive will not be attenuated and thereby create difficulty in recognizing following phonemes.

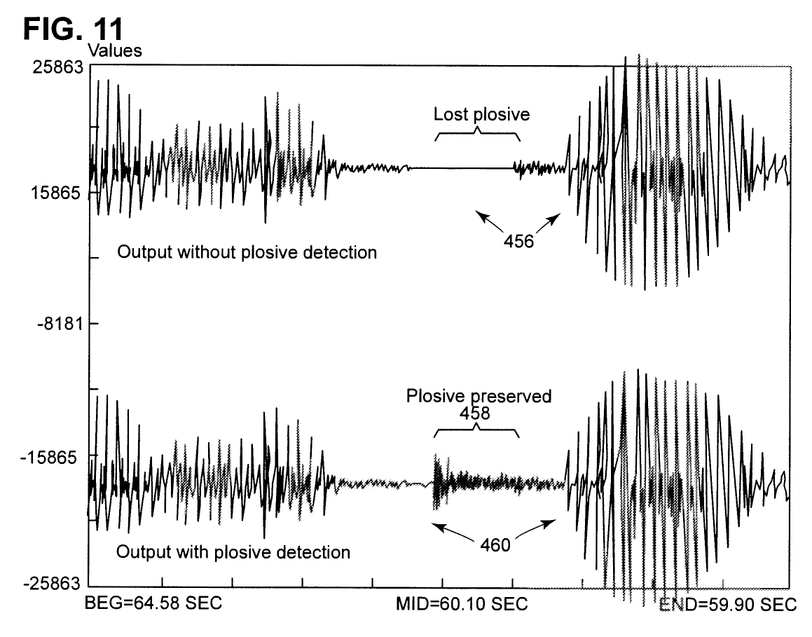

FIG. 11 shows an output of a system for detection and modifying breath pauses 410 with and without the enhanced performance created by plosive detection. As can be seen therein, output 456 of a system 410 without plosive detection eliminates a plosive 458 from the output 456, whereas, with plosive detection, represented by output 460, the plosive is not removed.

Breath Noise Modification

Referring again to FIG. 8, one embodiment of the modification unit 418 for breath noise is shown. The modification unit 418 comprises a first switch 464 comprising multiple inputs 466, 468, 470 and 472. Multipliers 474, 476 and 478 are interconnected with the inputs 468, 470 and 472 and Gaussian noise generator 480, uniform noise generator 482 and a run-time parameter buffer 484. A second switch 486 is interconnected with a summation unit 488, a Gaussian noise generator 481 and a uniform noise generator 483.

In operation, one of four modes may be selected via the first switch 464. The modes selectable are: 1) no alteration (input 466); 2) attenuation (input 468); 3) Gaussian noise (input 470); or 4) uniform noise (input 472). Where attenuation is selected, the speech input signal 412 is conducted to both the multiplier 474 and the breath detection unit 416 for attenuation of the appropriate portion of the speech input signal as described below. For operation of zero-level elimination, described in more detail below, the operator may select either Gaussian or uniform noise using the second switch 486.

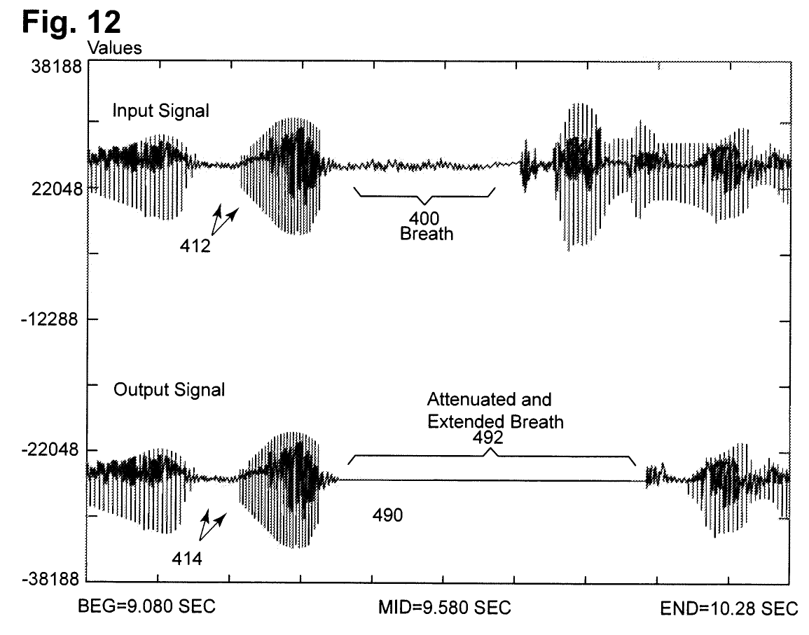

In accordance with one embodiment and referring to FIG. 12, the breath noise waveform 400 may be attenuated or replaced with fixed level artificial noise. One advantage of attenuating the breath noise waveform 400 is in reduced complexity of the system 410. One advantage of replacing the breath noise waveform 400 with fixed level artificial noise is better operation of the ASR module 104 (FIG. 4) which is described in more detail below.

Where attenuation of the breath noise is used, the attenuation is applied gradually with time, using a linear taper. This is done to prevent a large discontinuity in the input waveform, which would be perceived as a sharp “click”, and would likely cause errors in the ASR module 104. In order to either attenuate or replace the breath noise, a transition region length of 256 samples (5.3 msec) has been found suitable to prevent any “clicks”. As shown in FIG. 12, the breath noise waveform 400 provided in the speech input signal 412 is shown as attenuated breath noise 490 in the output speech signal 414.

It may be further advantageous to extend a length of the attenuated breath noise 490 in order to, e.g., force the ASR module 104 (FIG. 4) to recognize a pause in the speech. Two parameters to be considered in the extending the attuated breath noise 490 is a minimum duration of a breath pause and a minimum time between pauses. Typically, the minimum duration of the pause is set according to what the ASR module 104 requires to identify a pause; typical values usually range from 150 to 250 msec. Natural pauses that exceed the minimum duration value are not extended.

The minimum time between pauses parameter is the amount of time to wait after a pause is extended (or after a natural pause greater than the minimum duration) before attempting to insert another pause. This parameter is set to determine a lag time of the ASR module 104.

Pauses may be extended using fixed amplitude uniformly distributed noise, and the same overlapped trapezoidal windowing technique is used to change from noise to signal and vice versa. An attenuated and extended breath pause 492 is shown in FIG. 12.

As pauses are extended in the output signal, it will be appreciated that any new, incoming data may be buffered, e.g. for later playout. This is generally not a problem because large memory areas are available on most implementation platforms available for the system 410 (and 100) described above. However, it is important to control memory growth, in a known manner, to prevent the system being slowed such that it cannot keep up with a voice. For this reason, the system is designed to drop incoming breath noise (or silence) frames within a pause after the minimum pause duration has passed. Buffered frames may be played out in place of the dropped frames. A voice activity detector (VAD) may be used to detect silence frames or frames with stationary noise.

In the case of replacing breath noise waveform 400 with artificial noise, the changeover between speech input signal 412 and artifical noise (and vice versa) may be accomplished using a linear fade-out of one signal summed with a corresponding linear fade-in of the other. This is sometimes referred to as overlapped trapezoidal windowing.

Zero Level Signal Processing

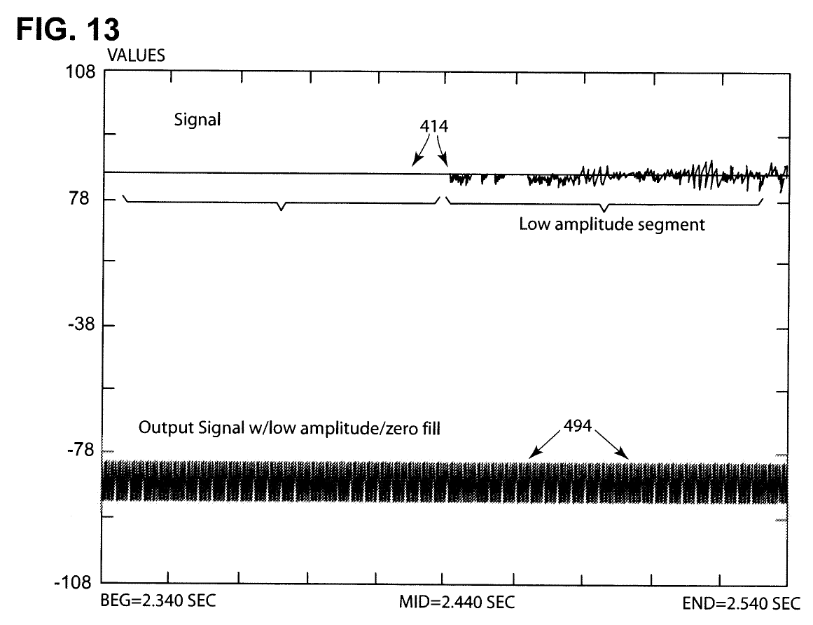

It has been found that a speech output signal 414 consisting substantially of zero-valued samples may cause the ASR module 104 (FIG. 4) to malfunction. In view of this, it is proposed to add low-amplitude, Gaussian- or uniformly distributed noise to an output signal from switch 464, shown in FIG. 8. To detect a zero- (or low-) valued segment, two approaches may be taken. For the first, a count is made of the number of zero-valued samples in a processed segment output from switch 464, and compare it to a predetermined threshold. If the number of zero samples is above the threshold, then the Gaussian or uniform noise is added. In the exemplary embodiment, the threshold is set at approximately 190 samples (for a 960 sample frame). In the second, the RMS level of the output is measured and compared it to a threshold. If the RMS level is below the threshold, the Gaussian or uniform noise is added. In the exemplary embodiment a threshold of 1.0 (for a 16 bit A/D) may be used. FIG. 13 shows an example of a speech output signal 414 and a speech output signal with low amplitude/zero fill.

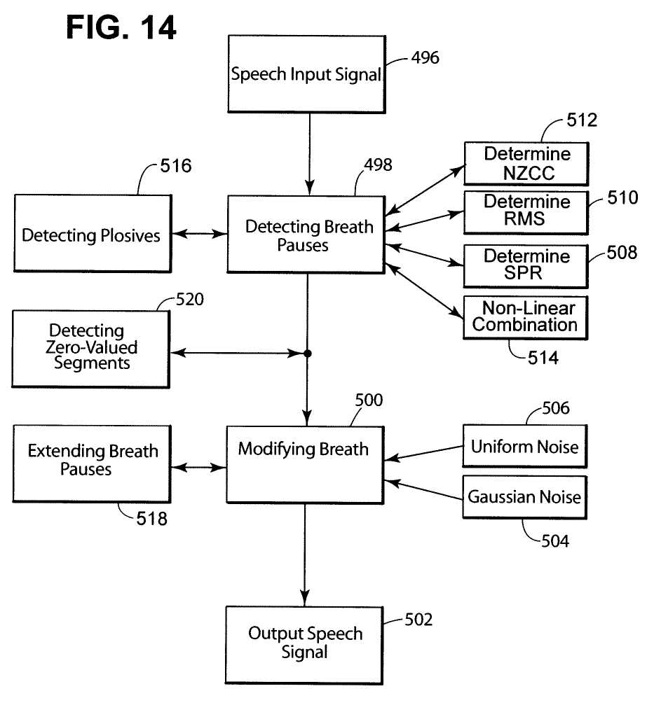

A further embodiment of the present invention is shown in FIG. 14, there a method is shown for detecting and modifying breath pauses in a speech input signal 496 which comprises detecting breath pauses in a speech input signal 498; modifying the breath pauses by replacing the breath pauses with a predetermined input and/or attenuating the breath pauses 500; and outputting an output speech signal 502. The method may further comprise using at least one of uniform noise 504 and Gaussian noise 506 for the predetermined input and further determining at least one of a normalized zero crossing count 508, a relative root-mean-square signal level 510, and a spectral power ratio 512. In a further embodiment the method may comprise determining each of the normalized zero crossing count 508, the relative root-mean-square signal level 510, the spectral power ratio 512 and a non-linear combination 514 of each of the normalized zero crossing count, the relative root-mean-square signal level and the spectral power ratio. The method may further comprise detecting plosives 516, extending breath pauses 518, and detecting zero-valued segments 520. A computer program embodying this method is also contemplated by this invention.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method for detecting and modifying breath pauses in a speech input signal, the method comprising:
detecting breath pauses in a speech input signal;
modifying the breath pauses by replacing the breath pauses with a predetermined input and/or attenuating the breath pauses; and
outputting an output speech signal.

2. The method of claim 1, wherein the predetermined input is at least one of uniform noise and Gaussian noise and wherein detecting breath pauses comprises determining at least one of a normalized zero crossing count, a relative root-mean-square signal level, and one or more spectral power ratios.

3. The method of claim 2, wherein detecting breath pauses further comprises determining each of the normalized zero crossing count, the relative root-mean-square signal level, the spectral power ratio(s) and a non-linear combination of each of the normalized zero crossing count, the relative root-mean-square signal level and the one or more spectral power ratios.

4. The method of claim 3, wherein detecting breath pauses further comprises determining a contribution of +1, 0, −1 or −2 for each of the normalized zero crossing count, the relative root-mean-square signal level, the one or more spectral power ratios and the non-linear combination and wherein detecting breath pauses further comprises determining a pscore by combining each the contributions for each of the normalized zero crossing count, the relative root-mean-square signal level, the one or more spectral power ratios and the non-linear combination.

5. The method of claim 4, wherein detecting breath pauses further comprises determining the pscore over a predetermined number of audio frames and wherein detecting breath pauses still further comprises summing each pscore for each particular frame over the predetermined number of audio frames to determine a composite detection score.

6. The method of claim 5, wherein the composite detection score is determined for each of the normalized zero crossing count (NZCC), the relative root-mean-square (RRMS) signal level, the spectral power ratio and the non-linear combination based on the below:

| | | |
|---|---|---|
| NZCC: | if (0.09 < ZCN < 0.22) | pscore++; |
| RRMS: | if (RRMS < 0.085) | pscore++; |
| | else if (RRMS > 0.1) | pscore−−; |
| Spectral | if (lo-hi < 5) AND (hiwide-lowide > −250) | pscore−−; |
| Ratios: | if (lo-hi < −50) | pscore−−; |
| | if (lo-mid > 200) AND (lo-hi < 120) | pscore−−; |
| | if (hiwide-lowide > −100) | pscore −= 2; |
| | |
|---|---|
| Non-linear | if the NZCC and RRMS criteria had positive contributions, |
| Comb: | and the spectral ratio net contribution was zero, pscore++; |

where: ZCN is found by dividing a number of times a signal changes polarity within a frame by a length of the frame in samples; and
RRMS is found using the logic:
if (rms>prms) prms=rms;
prms*=DECAY_COEFF;
rrms=rms/prms;
where rms is the current frame's RMS value, PRMS is the peak-hold AR average RMS, DECAY_COEFF is a positive number less than 1.0.

7. The method of claim 6, wherein:
the method further comprises high pass filtering the speech input signal prior to detecting breath pauses; and
wherein determining spectral ratios comprise using a 4-term Blackman-Harris window, a 1024-point FFT, and N filter ratio calculators, where N=a predetermined number of spectral power ratios.

8. The method of claim 1, wherein detecting breath pauses further comprises detecting plosives.

9. The method of claim 8, wherein detecting plosives comprises either determining:
(rms_half2/rms_half1>5) OR (rms_current_frame/rms_last_frame>5);
(NZCC has positive pscore contribution) OR (the composite detection score>3); and
(the composite detection score<20); or
determining:
(current_frame_pscore<0) AND (composite detection score<20); and
(the composite detection score>=9) OR (last_frame_pscore>=3).

10. The method of claim 1, wherein modifying the breath pauses comprises selecting one of four modes, the modes selectable comprise no alteration of the speech input signal; attenuation of the speech input signal; the replacement of a breath pause with Gaussian noise; and the replacement of a breath pause with uniform noise.

11. The method of claim 1, wherein modifying breath pauses comprises extending a breath pause.

12. The method of claim 1, further comprising detecting zero-valued samples in a processed segment output from the breath detection unit.

13. The method of claim 12, wherein detecting zero-valued samples comprises counting a number of zero-valued samples and comparing the number to a predetermined threshold, where the number of zero-valued samples is above the threshold, further comprising adding uniform or Gaussian noise to the output speech signal.

14. The method of claim 1 being employed with a method for generating closed captions from an audio signal, the method for generating closed captions comprising:
correcting one additional predetermined undesirable attribute from the audio signal and outputting one or more speech segments;
generating from the one or more speech segments one or more text transcripts;
providing at least one pre-selected modification to the text transcripts; and
broadcasting the text transcripts corresponding to the speech segments as closed captions.

15. The method of claim 14, further comprising performing real-time system configuration.

16. The method of claim 15, further comprising:
identifying specific speakers associated with the speech segments; and
providing an appropriate individual speaker model.

17. The method of claim 16, wherein the one or more predetermined undesirable attributes comprises at least one of voice activity detection and crosstalk elimination.

18. The method of claim 17, wherein the at least one pre-selected modification to the text transcripts comprises at least one of context, error correction, vulgarity cleansing, and smoothing and interleaving of captions.

19. A computer program embodied on a computer readable medium and configured for detecting and modifying breath pauses in a speech input signal, the computer program comprising the steps of:
detecting breath pauses in a speech input signal;
modifying the breath pauses by replacing the breath pauses with a predetermined input and/or attenuating the breath pauses; and
outputting an output speech signal.

20. The computer program of claim 19, wherein the predetermined input is at least one of uniform noise and Gaussian noise and wherein detecting breath pauses comprises determining at least one of a normalized zero crossing count, a relative root-mean-square signal level, and one or more spectral power ratios.

21. The computer program of claim 20, wherein detecting breath pauses further comprises determining a contribution of +1, 0, −1 or −2 for each of the normalized zero crossing count, the relative root-mean-square signal level, the one or more spectral power ratios and the non-linear combination and wherein detecting breath pauses further comprises determining a pscore by combining each the contributions for each of the normalized zero crossing count, the relative root-mean-square signal level, the one or more spectral power ratios and the non-linear combination.

22. The computer program of claim 21, wherein detecting breath pauses further comprises determining the pscore over a predetermined number of audio frames and wherein detecting breath pauses still further comprises summing each pscore for each particular frame over the predetermined number of audio frames to determine a composite detection score.

23. The computer program of claim 22, further comprising filtering the speech input signal prior to detecting breath pauses; and
wherein the composite detection score is determined for each of the normalized zero crossing count (NZCC), the relative root-mean-square (RRMS) signal level, the spectral power ratio and the non-linear combination based on the below:

| | | |
|---|---|---|
| NZCC: | if (0.09 < ZCN < 0.22) | pscore++; |
| RRMS: | if (RRMS < 0.085) | pscore++; |
| | else if (RRMS > 0.1) | pscore−−; |
| Spectral | if (lo-hi < 5) AND (hiwide-lowide > −250) | pscore−−; |
| Ratios: | if (lo-hi < −50) | pscore−−; |
| | if (lo-mid > 200) AND (lo-hi < 120) | pscore−−; |
| | if (hiwide-lowide > −100) | pscore −= 2; |
| | |
|---|---|
| Non-linear | if the NZCC and RRMS criteria had positive contributions, |
| Comb: | and the spectral ratio net contribution was zero, pscore++; |

where: ZCN is found by dividing a number of times a signal changes polarity within a frame by a length of the frame in samples; and
RRMS is found using the logic:
if (rms>prms) prms=rms;
prms*=DECAY_COEFF;
rrms=rms/prms;
where rms is the current frame's RMS value, PRMS is the peak-hold AR average RMS, DECAY_COEFF is a positive number less than 1.0.

24. The computer program of claim 19, wherein detecting breath pauses further comprises detecting plosives.

25. The computer program of claim 24, wherein detecting plosives comprises either determining:
(rms_half2/rms_half1>5) OR (rms_current_frame/rms_last_frame>5);
(NZCC has positive pscore contribution) OR (the composite detection score>3); and
(the composite detection score<20); or
determining:
(current_frame_pscore<0) AND (composite detection score<20); and
(the composite detection score>=9) OR (last_frame_pscore>=3).

26. The computer program of claim 19, wherein modifying the breath pauses comprises selecting one of four modes, the modes selectable comprise no alteration of the speech input signal; attenuation of the speech input signal; replacing a breath pause with Gaussian noise; and replacing a breath pause with uniform noise.

27. The computer program of claim 19, wherein modifying breath pauses comprises extending a breath pause.

28. The computer program of claim 19, further comprising detecting zero-valued samples in a processed segment output from the breath detection unit and wherein detecting zero-valued samples comprises counting a number of zero-valued samples and comparing the number to a predetermined threshold, where the number of zero-valued samples is above the threshold, further comprising adding uniform or Gaussian noise to the output speech signal.

29. The computer program of claim 19 being employed with a computer program for generating closed captions from an audio signal, the computer program for generating closed captions comprising:
correcting one additional predetermined undesirable attribute from the audio signal and outputting one or more speech segments;
generating from the one or more speech segments one or more text transcripts;
providing at least one pre-selected modification to the text transcripts; and
broadcasting the text transcripts corresponding to the speech segments as closed captions.

30. The computer program of claim 29, further comprising performing real-time system configuration.

31. The computer program of claim 30, further comprising:
identifying specific speakers associated with the speech segments; and
providing an appropriate individual speaker model.

32. The computer program of claim 31, wherein the one or more predetermined undesirable attributes comprises at least one of voice activity detection and crosstalk elimination.

33. The computer program of claim 32, wherein the at least one pre-selected modification to the text transcripts comprises at least one of context, error correction, vulgarity cleansing, and smoothing and interleaving of captions.
